(19) United States
(12) Patent Application Publication
(10) Pub. No.: US 2024/0123766 A1
(43) Pub. Date: Apr. 18, 2024

(54) FLAT-SPOT-PROOF TIRE, AND VEHICLE HAVING THE SAME

(71) Applicant: Zhejiang Geely Holding Group Co., Ltd, Hangzhou (CN)

(72) Inventors: Lamei TANG, Ningbo (CN); Xiangying XING, Ningbo (CN)

(73) Assignees: Zhejiang Geely Holding Group Co., Ltd, Hangzhou, ZJ (CN); Zhejiang Liankong Technologies Co., Ltd., Ningbo, ZJ (CN)

(21) Appl. No.: 18/277,571

(22) PCT Filed: Mar. 12, 2021
(86) PCT No.: PCT/CN2021/080483

§ 371 Date: Aug. 16, 2023

(51) Int. Cl. B60C 9/20

(52) U.S. Cl. CPC B60C 9/20; B60C 9/2009; B60C 2009/1828

(57) ABSTRACT

A flat spot-proof tire, and a vehicle. The flat spot-proof tire comprises a tread, a cap ply, a belt ply and a carcass. The rubber hardness of the tread is 68-78 Shore A. The cap ply is formed by nylon cords having linear density of 90-140 pieces per 100 mm. The belt ply is formed by steel cords, which comprise HT steel wires and/or SHT steel wires. The carcass is formed by polyester cords having linear density of 100-120 pieces per 100 mm. The flat spot-proof tire and the vehicle use suitable industrial rubber and polyester fiber material, have a specific size design and undergo an optimized inflation process after vulcanization such that the long-term flat spot effects of the tire can be mitigated, and the jitter of the vehicle during high-speed traveling can be reduced.

### TECHNICAL FIELD

The present document relates to vehicle tire technologies, in particular to a flat-spot-proof tire and a vehicle having the same.

### BACKGROUND

Due to viscoelastic properties of rubber materials, traditional tires are prone to flat spots at their stress mark points during exporting vehicles from main engine factories under long-term local stress conditions. According to the duration of sea transportations and the thermal and light environments, flat spots have short-term and long-term effects. Generally, the short-term flat spots can be eliminated, while the long-term flat spots cannot be eliminated.

In the related technologies, the design of tires can avoid some short-term flat spots by selecting fiber materials of the carcass, but does not have good effect on long-term flat spots, while the long-term flat spots can easily lead to vehicle jitter during high-speed traveling.

### SUMMARY

The present document is proposed to solve the technical problems that the tires are prone to long-term flat spot effect in the related art.

In order to solve the technical problems, the present document discloses a flat-spot-proof tire, which includes a tread, a cap ply, a belt ply, and a carcass;

A rubber hardness of the tread is in a range from 68 to 78 Shore A;

The cap ply is made of nylon cords having a linear density of 90 to 140 pieces per 100 mm;

The belt ply is made of steel cords being selected from HT steel wires and SHT steel wires;

The carcass is made of polyester cords having a linear density of 100 to 120 pieces per 100 mm.

In some embodiments, the flat-spot-proof tire also includes a bead filler having a rubber hardness of 74 to 90 Shore A.

In some embodiments, a height of the bead filler is in a range from 25 to 35 millimeters.

In some embodiments, a ground clearance of a shoulder of the flat-spot-proof tire is in a range from 6.5 to 8.5 millimeters.

In some embodiments, a vulcanization time of the flat-spot-proof tire is in a range from 16 to 18 minutes, and an inflation pressure after vulcanization is in a range from 1.2 to 1.4 bar.

In some embodiments, the nylon cords are PA66 wires having a fineness of 930 deniers and a linear density of 134 pieces per 100 mm.

In some embodiments, the steel cords are HT steel wires having a diameter of 0.25 millimeters, and the HT steel wires are twisted into 2+2*0.25HT strands.

In some embodiments, the polyester cord are PET wires having a fineness of 1500 deniers and a linear density of 118 pieces per 100 mm.

In some embodiments, the nylon cords are PA66 wires having a fineness of 1200 deniers and a linear density of 97 pieces per 100 mm.

The present document also discloses a vehicle, which includes any one of the aforementioned flat-spot-proof tires.

By means of the abovementioned technical solutions, the flat-spot-proof tire and the vehicle in the present document have the following advantages:

The flat-spot-proof tire and the vehicle of the present document use suitable industrial rubber and fiber polyester materials, have a specific size design and an optimized inflation process after vulcanization, such that the long-term flat spot effect of the tire can be mitigated, and the jitter of the vehicle during high-speed traveling can be reduced.

### BRIEF DESCRIPTION OF THE DRAWINGS

In order to clearly explain of the technical solutions in the embodiments of the present document, the following will give a brief introduction of the accompany drawings required in the description of the embodiments. Obviously, the accompany drawings in the following description only show some of the embodiments in the present document. For those having ordinary skill in the art, other drawings can also be obtained based on these drawings without any creative work.

FIG. 1 is a schematic structural diagram of an optional flat-spot-proof tire in an embodiment of the present document.

### DETAILED DESCRIPTION OF PREFERRED EMBODIMENTS

The following will provide a clear and complete description of the technical solution in the embodiments of the present document in conjunction with the accompanying drawings. Obviously, the described embodiments are only a part but not all of the embodiments of the present document. Based on the embodiments in the present document, all other embodiments obtained by those having ordinary skill the art without creative work will fall within the protection scope of the present document.

The term ‘one embodiment’ or ‘embodiment’ refers to a specific feature, structure, or characteristic that can be included in at least one implementation of the present document. In the description of the present document, it should be understood that the terms “up”, “down”, “top”, “bottom”, and etc. indicate the orientation or position relationship based on the orientation or position relationship shown in the attached drawings, only for the convenience of describing the present document and simplifying the description, rather than indicating or implying that the device or element must have a specific orientation, be constructed and operated in a specific orientation, and therefore cannot be understood as a limitation of the present document. In addition, the terms “first” and “second” are only used to describe and cannot be understood as indicating or implying the importance or inherently indicating the quantity of the technical features. Therefore, the features limited by “first” and “second” can explicitly or implicitly include one or more of these features. Moreover, the terms “first”, “second”, and etc. are used to distinguish similar objects without describing a specific order or sequence. It should be understood that the data used in this way can be interchanged in appropriate cases, so that the embodiments of the present document can be implemented in an order other than those illustrated or described here.

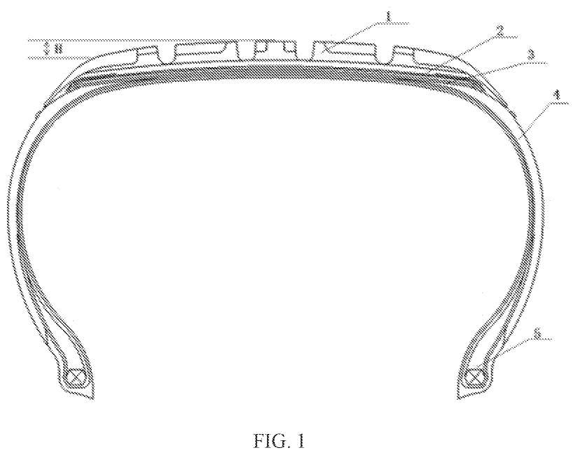

Please refer to FIG. 1, which is a structural schematic diagram of an optional flat-spot-proof tire in an embodiment of the present document. FIG. 1 shows a tread 1, a cap ply 2, a belt ply 3, a carcass 4, a bead filler 5, and a ground clearance H of a tire shoulder.

The flat-spot-proof tire and the vehicle in embodiments of the present document use suitable industrial rubber and fiber polyester materials, have a specific size design, and an optimized inflation process after vulcanization, such that the long-term flat spot effect of the tire can be mitigated, and the jitter of the vehicle during high-speed traveling can be reduced.

In the present document, a rubber hardness of the tread 1 is in a range from 68 to 78 Shore A; The cap ply 2 is made of nylon cords, and a linear density of the nylon cords is in a range from 90 to 140 pieces per 100 mm; The belt ply 3 is made of steel cords, and the steel cords are selected from a group consisting of HT steel wires and SHT steel wires; The carcass 4 is made of polyester cords, and a linear density of the polyester cords is in a range from 100 to 120 pieces per 100 mm.

In some embodiments, a rubber hardness of the bead filler 5 shown in FIG. 1 is in a range from 74 to 90 Shore A.

In some embodiments, a height of the bead filler 5 shown in FIG. 1 is in a range from 25 to 35 millimeters.

In some embodiments, the ground clearance H of the tire shoulder shown in FIG. 1 is in a range from 6.5 to 8.5 millimeters.

In some embodiments, a vulcanization time of the flat-spot-proof tire is in a range from 16 to 18 minutes, and an inflation pressure after vulcanization is in a range from 1.2 to 1.4 bar.

In some embodiments, the nylon cords are PA66 wires. A fineness of the nylon cords is 930 deniers and a linear density of the nylon cords is 134 pieces per 100 mm.

In some embodiments, the steel cords are HT steel wires. A diameter of the HT steel wires is 0.25 millimeters, and the HT steel wires are twisted into 2+2*0.25HT strands.

In some embodiments, the polyester cords are PET wires. A fineness of the PET wires is 1500 deniers and a linear density of the PET wires is 118 pieces per 100 mm.

In some embodiments, the nylon cords are PA66 wires. A fineness of the PA66 wires is 1200 deniers and a linear density of the PA66 wires is 97 pieces per 100 mm.

The following is an explanation of the flat-spot-proof tire in specific examples of the present document.

### Example 1

The rubber hardness of the tread 1 is 68 Shore A. The cap ply 2 is made of PA66 nylon cords, with a fineness of 930 deniers and a linear density of 97 pieces per 100 mm. The belt ply 3 is made of HT steel wires with a diameter of 2.3 mm, and the HT steel wires are twisted into 1*2*2.30 HT strand. The carcass 4 is made of PET polyester cords, with a fineness of 1000 deniers and a linear density of 100 pieces per 100 mm. The rubber hardness of the bead filler 5 is 88 Shore A, and the height of the bead filler 5 is 25 millimeters. The ground clearance of the tire shoulder is 6.5 millimeters. The vulcanization time of the tire is 16 minutes, and the inflation pressure after vulcanization is 1.2 bar.

### Example 2

The rubber hardness of the tread 1 is 70 Shore A. The cap ply 2 is made of PA66 nylon cords, with a fineness of 930 deniers and a linear density of 134 pieces per 100 mm. The belt ply 3 is made of HT steel wires with a diameter of 0.25 mm, and the HT steel wires are twisted into 2+2*0.25HT strand. The carcass 4 is made of PET polyester cords, with a fineness of 1500 deniers and a linear density of 118 pieces per 100 mm. The rubber hardness of the bead filler 5 is 74 Shore A, and the height of the bead filler 5 is 30 millimeters. The ground clearance of the tire shoulder is 8.5 millimeters. The vulcanization time of the tire is 18 minutes, and the inflation pressure after vulcanization is 1.4 bar.

### Example 3

The rubber hardness of the tread 1 is 74 Shore A. The cap ply 2 is made of PA66 nylon cords, with a fineness of 930 deniers and a linear density of 134 pieces per 100 mm. The belt ply 3 is made of HT steel wires with a diameter of 2.3 mm, and the HT steel wires are twisted into 1*2*2.30 HT strand. The carcass 4 is made of PET polyester cords, with a fineness of 1500 deniers and a linear density of 118 pieces per 100 mm. The rubber hardness of the bead filler 5 is 74 Shore A, and the height of the bead filler 5 is 30 millimeters. The ground clearance of the tire shoulder is 6.5 millimeters. The vulcanization time of the tire is 18 minutes, and the inflation pressure after vulcanization is 1.4 bar.

### Example 4

The rubber hardness of the tread 1 is 78 Shore A. The cap ply 2 is made of PA66 nylon cords, with a fineness of 1200 deniers and a linear density of 97 pieces per 100 mm. The belt ply 3 is made of HT steel wires with a diameter of 2.3 mm, and the HT steel wires are twisted into 1*2*2.30 HT. The carcass 4 is made of PET polyester cords, with a fineness of 1000 deniers and a linear density of 100 pieces per 100 mm. The rubber hardness of the bead filler 5 is 74 Shore A, and the height of the bead filler 5 is 35 millimeters. The ground clearance of the tire shoulder is 8.5 millimeters. The vulcanization time of the tire is 18 minutes, and the inflation pressure after vulcanization is 1.4 bar.

Table 1 shows z-jitter data of a steering wheel after vehicle tires manufactured by the techniques of Examples 1 to 4 generate flat spot. In Table 1, the tires being manufactured by the technique of Example 2 have the best performance. In the test of z-jitter data of the steering wheel after flat spot, the average data corresponding to the tires using the technique of Example 2 is 6.95 m/s, while the average data corresponding to the tires using the technique of Example 1 is 8.21 m/s.

TABLE 1

| | Jitter Data m/s | | | |
|---|---|---|---|---|
| Vehicle Speed KPH | Example 1 | Example 2 | Example 3 | Example 4 |
| 80 | 13.3 | 12.2 | 13.8 | 13 |
| 85 | 16.3 | 9.8 | 13 | 10.4 |
| 90 | 9.7 | 8.2 | 8.5 | 7.6 |
| 95 | 9.8 | 9.3 | 7.5 | 8.4 |
| 100 | 6.7 | 5.2 | 5.7 | 5.6 |
| 105 | 7.2 | 7.7 | 7.4 | 7.8 |
| 110 | 7.3 | 7.2 | 7.9 | 7.2 |
| 115 | 7.7 | 6.1 | 7.3 | 6.8 |
| 120 | 6.3 | 5.2 | 7.1 | 6.6 |
| 125 | 5.6 | 4.9 | 6.9 | 5.8 |
| 130 | 5.9 | 5.2 | 6.6 | 5.7 |
| 135 | 5.4 | 4.8 | 6.4 | 4.9 |
| 140 | 5.5 | 4.6 | 6.6 | 6.4 |
| Average | 8.21 | 6.95 | 8.05 | 7.40 |

The embodiments of the present document also provide a vehicle, which includes any one of the abovementioned flat-spot-proof tires.

The flat-spot-proof tire of the embodiments of the present document has the following advantages:

The flat-spot-proof tire and the vehicle of the embodiments of the present document use suitable industrial rubber and fiber polyester materials, have a specific size design, and an optimized inflation process after vulcanization, such that the long-term flat spot effect of the tire can be mitigated, and the jitter of the vehicle during high-speed traveling can be reduced.

The above examples are only preferred embodiments and are not intended to limit the present document. Any modifications, equivalent substitutions, improvements, and etc. made within the spirit and principles of the present document shall be included in the scope of protection of the present document.

1. A flat-spot-proof tire, comprising: a tread, a cap ply, a belt ply, and a carcass, wherein a rubber hardness of the tread is in a range from 68 to 78 Shore A;
the cap ply is made of nylon cords having a linear density of 90 to 140 pieces per 100 mm;
the belt ply is made of steel cords being selected from HT steel wires and SHT steel wires;
the carcass is made of polyester cords having a linear density of 100 to 120 pieces per 100 mm.

2. The flat-spot-proof tire according to claim 1, wherein the flat-spot-proof tire further comprises a bead filler having a rubber hardness of 74 to 90 Shore A.

3. The flat-spot-proof tire according to claim 2, wherein a height of the bead filler is in a range from 25 to 35 millimeters.

4. The flat-spot-proof tire according to claim 3, wherein a ground clearance of a shoulder of the flat-spot-proof tire is in a range from 6.5 to 8.5 millimeters.

5. The flat-spot-proof tire according to claim 4, wherein a vulcanization time of the flat-spot-proof tire is in a range from 16 to 18 minutes, and an inflation pressure after vulcanization is in a range from 1.2 to 1.4 bar.

6. The flat-spot-proof tire according to claim 5, wherein the nylon cords are PA66 wires having a fineness of 930 deniers and a linear density of 134 pieces per 100 mm.

7. The flat-spot-proof tire according to claim 6, wherein the steel cords are HT steel wires having a diameter of 0.25 millimeters and being twisted into 2+2*0.25HT strands.

8. The flat-spot-proof tire according to claim 7, wherein the polyester cords are PET wires having a fineness of 1500 deniers and a linear density of 118 pieces per 100 mm.

9. The flat-spot-proof tire according to claim 5, wherein the nylon cords are PA66 wires having with a fineness of 1200 deniers and a linear density of 97 pieces per 100 mm.

10. A vehicle, comprising a flat-spot-proof tire which comprises: a tread, a cap ply, a belt ply, and a carcass,
wherein a rubber hardness of the tread is in a range from 68 to 78 Shore A:
the cap ply is made of nylon cords having a linear density of 90 to 140 pieces per 100 mm;
the belt ply is made of steel cords being selected from HT steel wires and SHT steel wires;
the carcass is made of polyester cords having a linear density of 100 to 120 pieces per 100 mm.

11. The vehicle according to claim 10, wherein the flat-spot-proof tire further comprises a bead filler having a rubber hardness of 74 to 90 Shore A.

12. The vehicle according to claim 11, wherein a height of the bead filler is in a range from 25 to 35 millimeters.

13. The vehicle according to claim 12, wherein a ground clearance of a shoulder of the flat-spot-proof tire is in a range from 6.5 to 8.5 millimeters.

14. The vehicle according to claim 13, wherein a vulcanization time of the flat-spot-proof tire is in a range from 16 to 18 minutes, and an inflation pressure after vulcanization is in a range from 1.2 to 1.4 bar.

15. The vehicle according to claim 14, wherein the nylon cords are PA66 wires having a fineness of 930 deniers and a linear density of 134 pieces per 100 mm.

16. The vehicle according to claim 15, wherein the steel cords are HT steel wires having a diameter of 0.25 millimeters and being twisted into 2+2*0.25HT strands.

17. The vehicle according to claim 16, wherein the polyester cords are PET wires having a fineness of 1500 deniers and a linear density of 118 pieces per 100 mm.

18. The vehicle according to claim 14, wherein the nylon cords are PA66 wires having with a fineness of 1200 deniers and a linear density of 97 pieces per 100 mm.
